(19) United States
(12) Patent Application Publication
(10) Pub. No.: US 2010/0107160 A1
(43) Pub. Date: Apr. 29, 2010

(54) Protecting computing assets with virtualization

(75) Inventor: Kattiganehalli Y. Srinivasan, Princeton Junction, NJ (US)

Correspondence Address: KING & SCHICKLI, PLLC, 247 NORTH BROADWAY, LEXINGTON, KY, 40507, US

(73) Assignee: Novell, Inc.

(21) Appl. No.: 12/290,269

(22) Filed: Oct. 29, 2008

(51) Int. Cl. G06F 9/455

(52) U.S. Cl. 718/1

(57) ABSTRACT

Methods and apparatus protect computing assets of a hardware platform hosting a plurality of guest virtual machines. One of the virtual machines is configured as a management domain that determines whether other virtual machines comply with a predetermined policy before they can be guested on the hardware platform. In one instance, an open virtual machine format (OVF) for virtual machines has attendant metadata that the management domain examines for the presence of a signature. If authentic, the management domain allows the installation of the virtual machine. If not, the management domain prevents its installation. In this manner, end-users are prevented from installing unapproved guest operating systems on corporate-owned hardware. Still other features contemplate preventing users from installing applications into existing domains by assigning various user and administrative rights. Computer program products for assisting in the foregoing are also disclosed.

### FIELD OF THE INVENTION

Generally, the present invention relates to computing devices and computing environments involving protection of computing assets, such as for a corporate entity. Particularly, although not exclusively, it relates to protection of a common hardware platform hosting pluralities of domains of virtual machines, especially by way of a management domain. Other features contemplate computing arrangements, preventing or allowing user installation, and computer program products, to name a few.

### BACKGROUND OF THE INVENTION

Today, corporate computing assets, such as laptops, phones, PDAs, etc., are distributed outside the corporate firewalls more than ever before. With more and more employees either working from home or working “on the road,” controlling and managing corporate IT assets is becoming a difficult or serious problem. For instance, many employers have little or no control on what software is installed and executed on corporate computers used by employees who work outside the physical boundaries of the corporation. Indeed, this problem also exists at some level for machines deployed within the corporate physical boundaries. This is not only a security threat for the corporate IT infrastructure, but may actually be an uncontrolled legal liability for the corporation, e.g., in terms of licensing compliance.

With the advent of virtual computing, such problems are exacerbated since a single hardware platform will often guest many virtual computing devices, each with its own operating system, drivers, interfaces, applications, etc. In that IT resources also extend to security for such assets, unknown or unapproved software on these assets further complicates protection, especially in the form of firewalls, virus applications, security appliances, etc. As is known, security appliances require additional infrastructure and capital expenditure for implementation, while firewalls and applications need tight correlation to operating system configurations. Also, the appliances are limited by how many devices it can effectively service, while the latter does not transfer well to other computing devices having vastly different operating systems, storage interfaces, files systems, etc.

Accordingly, a need exists in the art of providing computing protection for better control and management of installed items, such as software. Naturally, any improvements along such lines should further contemplate good engineering practices, such as ease of implementation, unobtrusiveness, stability, etc.

### SUMMARY OF THE INVENTION

The foregoing and other problems become solved by applying the principles and teachings associated with the hereinafter-described protecting computing assets with virtualization. At a high level, an embedded virtualization engine (e.g., the Novell Virtualization Platform) provides the foundation for structuring a controlled environment for hosting corporate-approved services on corporate computing assets. In one aspect, a management domain is configured on a computing device that determines whether other virtual machines can be also installed on the same computing device so as to prevent end-users from installing unapproved guest operating systems on corporate-owned hardware.

In certain embodiments, a hardware platform hosts a plurality of guest virtual machines. One of the virtual machines is configured as a management domain that determines whether other virtual machines comply with a predetermined policy before they can be guested on the hardware platform. In one instance, an open virtual machine format (OVF) for virtual machines has attendant metadata that the management domain examines for the presence or absence of a signature. If present, and if authentic, the management domain allows the installation of the virtual machine. If neither, the management domain prevents its installation. In this way, corporate policies are enforced on corporate hardware assets independent of the physical location of the hardware. In other features, users are prevented from installing applications into existing domains by assigning various user and administrative rights, and software is controlled and limited, especially to ensure compliance with software licensing.

In a particular apparatus embodiment, a hardware platform of a computing device typifies a laptop computer, server, general or special purpose computer, phone, PDA, etc. Also, it includes a processor and memory, and has access to a network and remote or local storage. A plurality of virtual machines, each operating as an independent guest computing device on the processor and memory by way of scheduling control from a hypervisor layer, access the network and/or remote or local storage during use, as is typical. However, one of the virtual machines is partitioned in the remote or local storage and configured to determine whether other of the virtual machines comply with a predetermined policy before they can be installed on the hardware platform. In a representative example, policy compliance is enforced by examining whether a signature is authentic in attendant metadata of an open virtual machine format for virtual machines.

To minimize the code footprint of such a design, the virtualization engine is exemplified by the Novell Virtualization Platform (NVP) product. The NVP is composed of a hypervisor and a management partition (minimal footprint or just-enough operating system (JeOS) Linux) as a single bootable image. Also, NVP is a closed environment in that (a) it cannot be patched and (b) the end-user cannot install additional software into it. NVP is distributed as a read-only image that can be embedded in a flash memory device. In turn, NVP is updated by flashing in a new version of the image as opposed to patching an existing image. (See also U.S. patent application Ser. No. 12/286,561, entitled “Flash Memory Device for Booting a Computing Device Including Embedded General Purpose Operating System” filed Oct. 1, 2008, and assigned to Novell, Inc., the contents of which are incorporated fully herein as if set forth herein.) Also, since the management partition of NVP is in control of virtual machines hosted on the hardware platform, license management can be centralized.

Executable instructions loaded on one or more computing devices for undertaking the foregoing are also contemplated as are computer program products available as a download or on a computer readable medium. The computer program products are also available for installation on a network appliance or individual computing devices.

These and other embodiments of the present invention will be set forth in the description which follows, and in part will become apparent to those of ordinary skill in the art by reference to the following description of the invention and referenced drawings or by practice of the invention. The claims, however, indicate the particularities of the invention.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a diagrammatic view in accordance with the present invention of a representative virtualized computing arrangement for protecting corporate computing assets;

FIGS. 2 and 3 are diagrammatic views in accordance with the present invention of the representative virtualized computing arrangement of FIG. 1, including analysis for adding a new domain; and

FIGS. 4 and 5 are diagrammatic views in accordance with the present invention of the representative virtualized computing arrangement of FIG. 1, including analysis for adding a new application.

### DETAILED DESCRIPTION OF THE ILLUSTRATED EMBODIMENTS

In the following detailed description of the illustrated embodiments, reference is made to the accompanying drawings that form a part hereof, and in which is shown by way of illustration, specific embodiments in which the invention may be practiced. These embodiments are described in sufficient detail to enable those skilled in the art to practice the invention and like numerals represent like details in the various figures. Also, it is to be understood that other embodiments may be utilized and that process, mechanical, electrical, arrangement, software and/or other changes may be made without departing from the scope of the present invention. In accordance with the present invention, methods and apparatus are hereinafter described for protecting computing assets with virtualization.

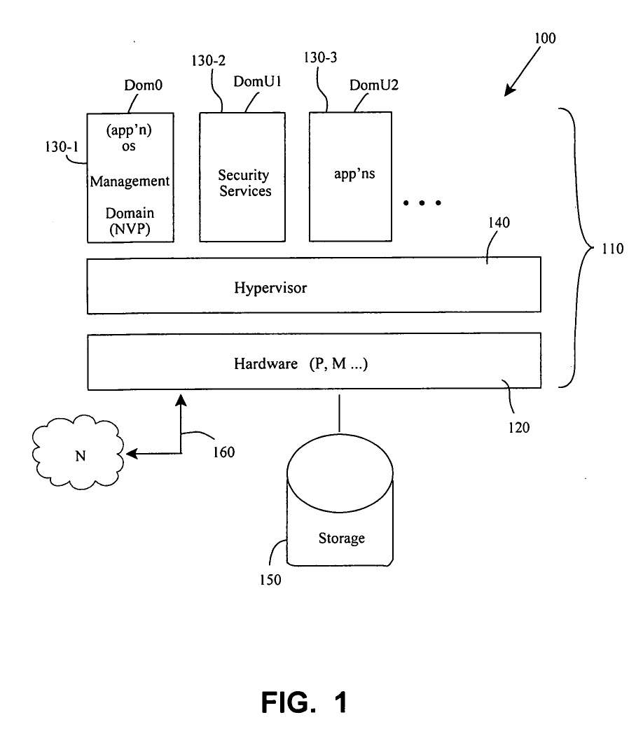

With reference to FIG. 1, a representative computing system environment 100 includes a to-be-protected computing asset 110. Representatively, the asset is a computing device in the form of a laptop computer, general or special purpose computer, a phone, a PDA, a server, etc., having a hardware platform 120. As is typical, the hardware platform embodies physical I/O and platform devices, memory (M) and a processor (P), such as a CPU, Disk, USB, etc. In turn, the hardware platform hosts one or more virtual machines 130-1, 130-2, 130-3, each having its own guest operating system (OS) (e.g., Linux, Windows, Netware, Unix, etc.), applications, file systems, etc. An intervening Xen, NVP (Novell Virtualization Platform) or other hypervisor layer 140, also known as a “virtual machine monitor,” or virtualization manager, is the virtual interface to the hardware and virtualizes the hardware. It is also the lowest and most privileged layer and performs scheduling control between the virtual machines as they task the resources of the hardware platform, storage 150, network (N), etc. The hypervisor also manages conflicts, among other things, caused by operating system access to privileged machine instructions. The hypervisor can also be type 1 (native) or type 2 (hosted), and skilled artisans understand the terminology. According to various partitions, the application data, boot data, or other data, executable instructions, etc., of the machines are virtually stored on available physical storage 150 that is either remote or local to the hardware platform, and such is typical in a virtual environment.

In more detail, the computing device can be of a traditional type, and can fulfill any future-defined or traditional role. In network, it is arranged to communicate 160 with one or more other computing devices/networks (N), and skilled artisans readily understand the configuration. For example, the computing device may use wired, wireless or combined connections, to other devices/networks and may be direct or indirect connections. If direct, they typify connections within physical or network proximity (e.g., intranet). If indirect, they typify connections such as those found with the internet, satellites, radio transmissions, or the like. In this regard, other contemplated items include other servers, routers, peer devices, modems, Tx lines, satellites, microwave relays or the like. The connections may also be local area networks (LAN), wide area networks (WAN), metro area networks (MAN), etc., that are presented by way of example and not limitation. The topology is also any of a variety, such as ring, star, bridged, cascaded, meshed, or other known or hereinafter invented arrangement.

Leveraging the foregoing, embodiments of the present invention pre-install and embed the hypervisor 140/management domain (NVP) 130-1 on the hardware platform before any other domain 130 to (a) make the hardware platform manageable and (b) enforce corporate policies. Namely, the management domain 130-1 is configured to determine whether other virtual machines comply with a predetermined policy before they can be guested on the hardware platform. If so, they are allowed to be installed. If not, they are prevented from installation. In this manner, end-users are prevented from installing unapproved guest operating systems on corporate-owned hardware.

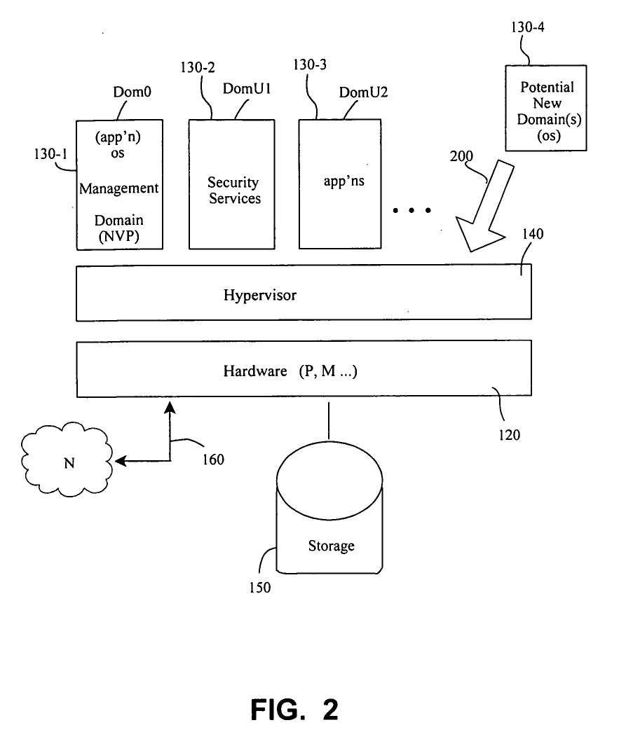

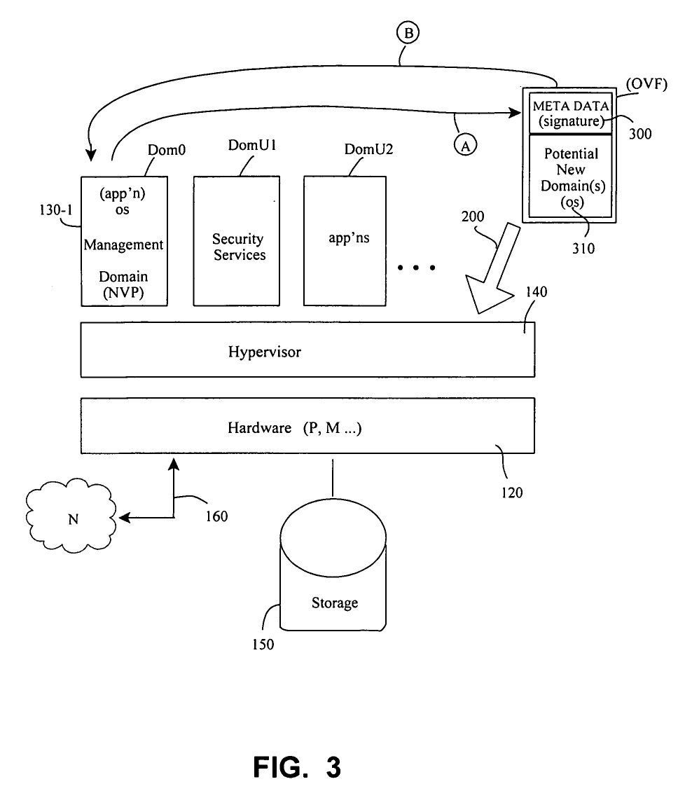

With reference to FIG. 2, for example, consider the scenario where a user of the hardware platform seeks to add or install 200 a new virtual machine 130-4, including its own operating system 310, to the hardware platform. With reference to FIG. 3, consider further that a corporate policy requires that only certified virtual machines be allowed for installation. Thus, the management domain 130-1 examines the virtual machine 130-4 to see if it has an appropriate signature 300 certified by, in this example, Novell, Inc. If so, the potential new domain can be installed on the hardware platform owned by Novell, Inc. Otherwise, it is prevented. Also, by leveraging the open virtual machine format (OVF) for virtual machines, the virtual machine 130-4 can be configured in a format known to the management domain. With the signature, then, in a known position in attendant metadata of the OVF, the management domain immediately knows where to look for the presence or absence of the signature, step A. Upon finding it, step B, the management domain can authenticate it. If authentic, the management domain allows the installation of the virtual machine. If not, the management domain prevents its installation.

Of course, other policies for allowing or preventing the installation of a new virtual machine are possible. For instance, the virtual machine may need to meet: a predetermined size; be of a type able to be configured on the processor and memory types/speeds/brands/etc. of the hardware platform; a predetermined vendor; a predetermined operating system type; or the like. Facilitating meeting or failing this policy, the OVF presently contemplates (as outlined in The Open Virtual Machine Format Whitepaper for OVF Specification, VMware, Inc.), for example, unique sections where the management domain could readily find certain information. As presently contemplated, the sections are 1) Productsection, which provides product information such as name and vendor of the appliance; 2) Propertysection, which list a set of properties that can be used to customize the appliance. Normally, these properties are configured at installation time of the appliance, typically by prompting the user; 3) Annotationsection, which is a free form annotation section; 4) EulaSection, the licensing term section for the appliance, and is also typically shown during install; 5) HardwareSection, which describes the virtual hardware. This is a required section that describes the kind of virtual hardware and set of devices that the virtual machine requires. In a fairly typical case, e.g., hardware is specified by 500 MB of guest memory, 1 CPU, 1 NIC, and one virtual disk; and 6) OperatingSystemSection, which describes the guest operating system. While other formats are possible within the scope of the invention, use of the OVF (or other known or later-invented formats) and the management domain's ability to recognize it, will only further advance the enforcement of policy before installation of a new virtual machine.

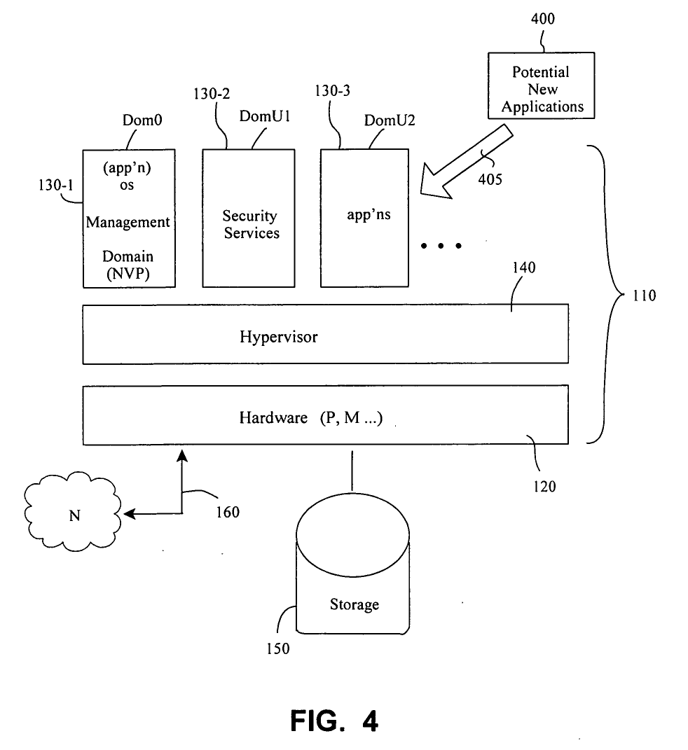

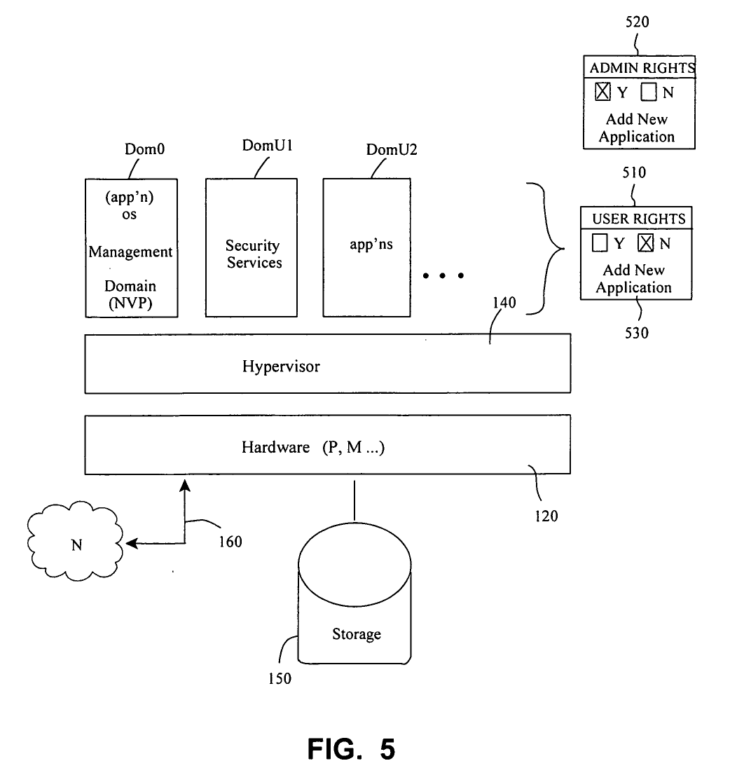

With reference to FIGS. 4 and 5, it is further contemplated to prevent inadvertent and/or unauthorized modification of application virtual machine images. Thus, it is a further embodiment to avoid authorizing end-users from installing 405 potential new applications or software 400 in any of the virtual machines 130. Namely, users are prevented from installing applications into existing domains by assigning various user 510 and administrative 520 rights, such as during appliance build. In this example, users are completely prevented from installing new applications 530 anywhere, but other examples are possible. For instance, other user rights, versus administrative rights, may come in the form of preventing downloading patches to existing applications, preventing deleting of applications, preventing moving applications from one domain to another, only executing approved services packaged as virtual machines, such as in domain 130-2, or the like. Naturally, skilled artisans will be able to contemplate others. Additionally, a set of approved security services (Firewall, Virus Scanning, etc.) can be pre-packaged and delivered as part of the managed hardware (in domain 130-2) to ensure uniformity and conformance across all corporate assets.

In any embodiment, skilled artisans will appreciate that enterprises can implement some or all of the foregoing with humans, such as system administrators, computing devices, executable code, or combinations thereof. In turn, methods and apparatus of the invention further contemplate computer executable instructions, e.g., code or software, as part of computer program products on readable media, e.g., disks for insertion in a drive of computing device, or available as downloads or direct use from an upstream computing device. When described in the context of such computer program products, it is denoted that executable instructions thereof, such as those bundled as components, modules, routines, programs, objects, data structures, etc., perform particular tasks or implement particular abstract data types within various structures of the computing system which cause a certain function or group of function, and enable the configuration of the foregoing.

Although the foregoing has been described in terms of specific embodiments, one of ordinary skill in the art will recognize that additional embodiments are possible without departing from the teachings of the present invention. This detailed description, therefore, and particularly the specific details of the exemplary embodiments disclosed, is given primarily for clarity of understanding, and no unnecessary limitations are to be implied, for modifications will become evident to those skilled in the art upon reading this disclosure and may be made without departing from the spirit or scope of the invention. Relatively apparent modifications, of course, include combining the various features of one or more figures with the features of one or more of other figures.

1. In a computing system environment, a method of protecting computing assets on a hardware platform hosting a plurality of guest virtual machines on a processor and memory of the hardware platform by way of scheduling control from a virtualization manager also configured on the hardware platform, comprising configuring one of the virtual machines to determine whether other of the virtual machines comply with a predetermined policy before said other of the virtual machines can be guested on the hardware platform.

2. The method of claim 1, further including configuring the one of the virtual machines to determine whether said other of the virtual machines have a certified signature.

3. The method of claim 1, further including configuring the one of the virtual machines to recognize whether said other of the virtual machines have an open virtual machine format.

4. The method of claim 1, further including configuring said other of the virtual machines to prevent users of the hardware platform from installing computing applications on the hardware platform.

5. The method of claim 1, further including configuring the one of the virtual machines to prevent users of the hardware platform from installing another virtual machine on the hardware platform unless said another virtual machine said complies with said predetermined policy.

6. In a computing system environment, a method of protecting computing assets on a hardware platform able to host a plurality of guest virtual machines on a processor and memory of the hardware platform by way of scheduling control from a virtualization manager also configured on the hardware platform, comprising:
partitioning one of the virtual machines in remote or local storage available to the hardware platform; and
configuring said one of the virtual machines to prevent installation of another virtual machine on the hardware platform unless said another virtual machine complies with a predetermined computing policy.

7. The method of claim 6, further including configuring said one of the virtual machines to determine whether said another virtual machine has a certified signature.

8. The method of claim 7, further including configuring said one of the virtual machines to recognize whether said another virtual machine has the certified signature in metadata of an open virtual machine format for virtual machines.

9. The method of claim 6, further including configuring other of the virtual machines to prevent users of the hardware platform from installing computing applications on the hardware platform.

10. In a computing system environment, a method of protecting computing assets on a hardware platform hosting a plurality of guest virtual machines on a processor and memory of the hardware platform by way of scheduling control from a virtualization manager also configured on the hardware platform, comprising:
partitioning one of the virtual machines in remote or local storage available to the hardware platform; and
configuring said one of the virtual machines to prevent installation of another virtual machine on the hardware platform unless said another virtual machine includes a certified signature in attendant metadata of an open virtual machine format for virtual machines.

11. A computing device, comprising:
a hardware platform including a processor and memory;
a hypervisor layer on the hardware platform; and
a plurality of virtual machines each operating as an independent guest computing device on the processor and memory by way of scheduling control from the hypervisor layer, wherein one of the virtual machines is configured to determine whether other of the virtual machines comply with a predetermined policy before said other of the virtual machines can be guested on the hardware platform.

12. The computing device of claim 11, wherein said one of the virtual machines is further configured to recognize whether said other of the virtual machines have an open virtual machine format.

13. The computing device of claim 11, wherein said one of the virtual machines is further configured to prevent installation of another virtual machine on the hardware platform unless said another virtual machine said complies with said predetermined policy.

14. A computing device, comprising:
a hardware platform including a processor and memory and having access to remote or local storage;
a hypervisor layer on the hardware platform; and
a plurality of virtual machines each operating as an independent guest computing device on the processor and memory by way of scheduling control from the hypervisor layer, wherein one of the virtual machines is partitioned in the remote or local storage and configured to determine whether other of the virtual machines comply with a predetermined policy before said other of the virtual machines can be installed on the hardware platform.

15. The computing device of claim 14, wherein the plurality of virtual machines are arranged in an open virtual machine format.

16. The computing device of claim 14, wherein the other of the virtual machines include a certified signature identifying a source providing the other of the virtual machines.

17. The computing device of claim 16, wherein the one of the virtual machines is further configured to authenticate the certified signature.

18. A computing device, comprising:
a hardware platform including a processor and memory and having access to remote or local storage;
a hypervisor layer on the hardware platform; and
a plurality of virtual machines each operating as an independent guest computing device on the processor and memory by way of scheduling control from the hypervisor layer, wherein one of the virtual machines is partitioned in the remote or local storage and configured to prevent installation of another virtual machine on the hardware platform unless said another virtual machine includes a certified signature in attendant metadata of an open virtual machine format for virtual machines.

19. A computing device, comprising:
a hardware platform including a processor and memory, the hardware platform having access to remote or local storage;
a hypervisor layer on the hardware platform;
a first guest virtual machine partitioned in the remote or local storage and operating as an independent guest computing device on the processor and memory by way of scheduling control from the hypervisor layer; and
a second guest virtual machine operating as another independent guest computing device on the processor and memory by way of scheduling control from the hypervisor layer, wherein the second guest virtual machine has a signature identifying a source of the second guest virtual machine and the first guest virtual machine is configured to authenticate the signature and upon authentication to allow installation of the second guest virtual machine on the hardware platform.

20. A computer program product available as a download or on a computer readable medium for loading on a computing device to protect computing assets on a hardware platform hosting a plurality of guest virtual machines on a processor and memory of the hardware platform by way of scheduling control from a virtualization manager also configured on the hardware platform, the computer program product having executable instructions to enable configuring one of the virtual machines to determine whether other of the virtual machines comply with a predetermined policy before said other of the virtual machines can be guested on the hardware platform.

21. The computer program product of claim 20, further including executable instructions to configure said one of the virtual machines to prevent installation of said other of the virtual machines for lack of compliance with the predetermined policy.

22. The computer program product of claim 20, further including executable instructions to configure said one of the virtual machines to determine whether said other of the virtual machines have a certified signature.

23. The computer program product of claim 20, further including executable instructions to configure said one of the virtual machines to recognize a virtual machine format of said other of the virtual machines.

24. A computer program product available as a download or on a computer readable medium for loading on a computing device to protect computing assets on a hardware platform hosting a plurality of guest virtual machines on a processor and memory of the hardware platform by way of scheduling control from a virtualization manager also configured on the hardware platform, the computer program product having executable instructions to enable configuring one of the virtual machines to prevent installation of other of the virtual machines on the hardware platform unless the other of the virtual machines include a certified signature in attendant metadata of an open virtual machine format for virtual machines.
